(19) United States
(12) Patent Application Publication
(10) Pub. No.: US 2014/0358521 A1
(43) Pub. Date: Dec. 4, 2014

(54) CAPTURE SERVICES THROUGH COMMUNICATION CHANNELS

(71) Applicant: Microsoft Corporation, Redmond, WA (US)

(72) Inventors: Ian William Mikutel, Redmond, WA (US); Jin Wang, Kirkland, WA (US); Manish Maheshwari, Bellevue, WA (US); Jason Morrill, Redmond, WA (US)

(21) Appl. No.: 13/909,083

(22) Filed: Jun. 4, 2013

(51) Int. Cl. G06F 17/27

(52) U.S. Cl. CPC G06F 17/2705
USPC 704/9

(57) ABSTRACT

Techniques and systems are presented for capturing content for a note through various communication channels including those for email, text, and voice. One technique includes receiving a message from a communication channel; parsing the message and determining semantic structure of the message; determining a presentation form for how the content is to be presented and used in a note from elements in the message; and inserting the message into the note according to the presentation form. Receipt of a message addressed to a uniform address may be used to indicate that the message is to be inserted into a note.

### BACKGROUND

Notebook applications (and services), such as MICROSOFT ONENOTE from Microsoft Corp. and EVERNOTE from Evernote Corp., are becoming popular for task management and content curation—the organization and presentation (or sharing) of content from various sources. Features of these and other notebook applications include capabilities of capturing, storing, and sharing all kinds of information including photographs, emails, business cards, wish lists, receipts, to-do lists, travel plans, and recipes. A note refers to the file, page, or pages in a notebook containing content.

To utilize the many capabilities of a notebook application, a user of one of the notebook applications currently captures and inserts content into a note through an application or tool running on their device that is directly associated with the notebook application. Often, when a user is in a separate application on their computing device, a clipper or other tool created by the notebook application is used to capture content from that separate application. However, there may be situations where a user would like to generate or capture content while operating within an application that is not associated with (or uses a capture tool of) one of the notebook applications.

### BRIEF SUMMARY

Techniques and systems are presented for capturing content for a note through various communication channels.

A method of capturing content through a communication channel is described that includes receiving a message from a communication channel such as an email service, text messaging service, or voice/telephony system; parsing the message and determining semantic structure of the message; determining a presentation form from elements in the message; and inserting the message into a note according to the presentation form.

A user may capture content or an idea without going through the steps of opening a notebook application or using a clipping tool. Instead, a message can be sent to an address indicative of a notebook application, and a message service receiving the message can process the message for inserting into a note.

According to one implementation, a message service of a capture service can include a message receiver configured to receive a message from a communication channel; and a parser configured to parse the message into tokens including elements and semantic markers in the message; recognize semantic structure of the elements in the message; and determine a presentation form from the elements in the message.

According to another implementation, content can be captured for a note through various communication channels. For example, a message having a source semantic structure based on a source of the message can be received at a message service. The message can be parsed based on the source semantic structure and, optionally, other parsing modalities (such as natural language). Content of the message can be determined and one or more entities can be recognized using the source semantic structure. Metadata associated with the one or more entities can be determined and stored associated with the message for inserting in to the note.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment in which implementations may be practiced.

FIG. 2 illustrates a system architecture diagram and process flow for an example implementation of a messaging communication channel.

FIG. 3 illustrates a system architecture diagram and process flow for an example implementation of an email communication channel.

FIGS. 4A-4C illustrate user experiences for transferring information to a note through a communication channel; FIG. 4A shows a message case and FIGS. 4B and 4C show an email case for an example scenario.

FIGS. 5A and 5B illustrate user experiences within a note after inputting information through a communication channel according to an example scenario; FIG. 5A shows a mobile client (such as a smart phone) implementation and FIG. 5B shows a client (such as a tablet or laptop).

FIG. 6 illustrates an example method of capturing content through a communication channel.

FIGS. 7A-7D illustrate representative steps that may be carried out when performing an example method of capturing content through a communication channel.

FIG. 8 illustrates a method of capturing content through a communication channel.

### DETAILED DESCRIPTION

Techniques and systems are presented for capturing content for a note through various communication channels. Communication channels include, but are not limited to, ubiquitous (or nearly ubiquitous) communication channels of email, text and multimedia messaging, and phone. It is contemplated that other communication channels may be used that are now known or later created and from which information sent over those channels can be parsed as described herein.

Certain embodiments are directed to using ubiquitous communication channels to capture information that a user desires to access, organize, and/or search at a later time. By using a communication channel that is within a user's existing behavior, additional pipelines of data entry into a notebook application or service can be facilitated.

In certain implementations, a uniform email address is presented that users can email for inserting content into a note. In other implementations a phone number or short code number can be provided for sending content through other communication channels.

Content curation, consumption and/or task management may be accomplished through a web-application based notebook application accessed via a browser or a notebook application running on a mobile device, tablet, or desktop that has at least occasional access to a network.

In addition to providing a repository for organizing and searching information, notebook applications (and services) can provide file saving and sharing in the cloud where notes can be synced across computers and devices. For example, in a notebook application such as ONENOTE or EVERNOTE, it is possible to save files to cloud storage or other location. Then, once content is saved to a note, the content can be viewed, edited, synced (across multiple devices), and shared. Some notebook applications enable a user to share notes in a manner that lets the user work together with family members, colleagues, or classmates on the same notes at the same time.

Getting content into a notebook may be achieved through direct entry, such as by inserting content or creating new content while within a notebook application or through a collection mechanism such as a clipping tool that can be used while the user is active in another application. Usually, a user opens a notebook application and inserts content or uses a clipping tool that can capture content being displayed on the user's device (an often as part of a web browser). However, there may be scenarios where a user would like to capture content or an idea without going through the steps of opening a notebook application or using a clipping tool.

Indeed, there may be a number of scenarios in which a person would like to make a note to themselves for later use or action. One case may involve capturing a quick to-do item, for example creating a grocery shopping list or other checkmark list. Another case may involve collecting information (of disparate data) on a product, destination, person, or other thing to remember for later planning, contacting, or decision making Yet another case may involve conducting research for a project, in which links to news stories or database articles as well as documents (and various versions) may be retained together and even annotated. Another case may involve planning or coordinating with others, for example by compiling images, video, audio, or text along with creating meetings and alarms for events and appointments. Further cases can involve capturing inspirational content for sharing with others.

In some cases, once the insertion of content into a note through a communication channel is accomplished, the content may be made available for consumption (and use by other programs) outside of the note or notebook application.

Implementations enable a user to take advantage of the features of a notebook service of a notebook application to accomplish these and other tasks by facilitating the transfer of data to the notebook service.

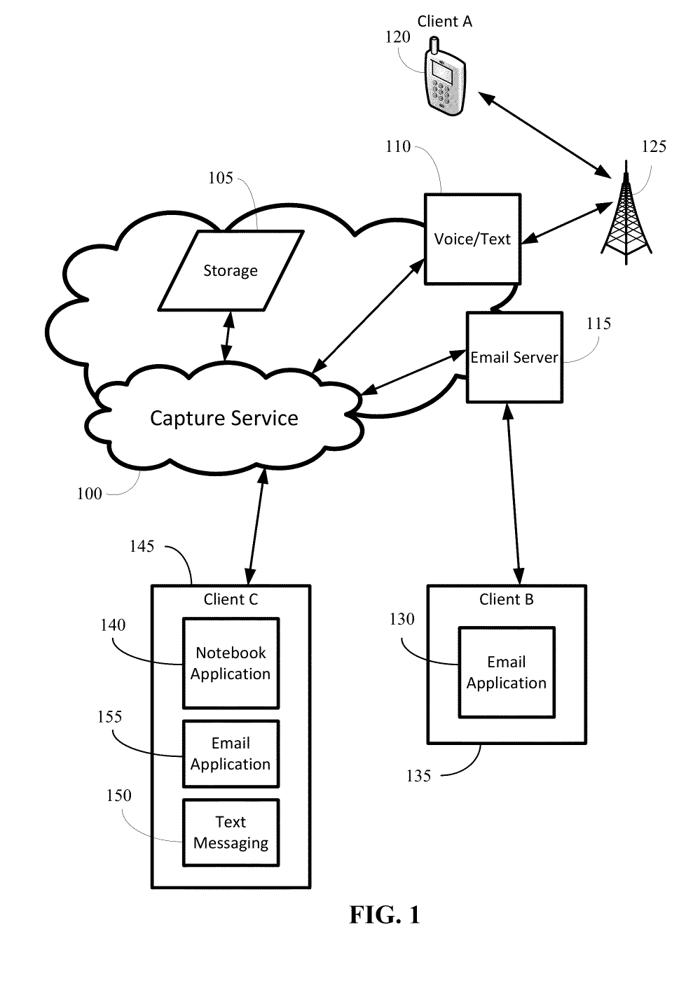

FIG. 1 illustrates an operating environment in which implementations may be practiced. Referring to FIG. 1, a capture service 100 can be used to capture content for a notebook application. Notes and other content may be stored in the “cloud” in a database or other storage structure 105 that may be distributed or centralized. The capture service 100 may be a cloud service or web service. A cloud service generally refers to hosted services providing scalable processing and storage capabilities. Web services can be provided and/or hosted by a cloud service (e.g., as part of a large-scale distributed computing environment). A web service is a software system that supports interoperable machine-to-machine interaction over a network and enables software to connect to other software applications.

Content can be captured for the notebook application (or simply stored for a user in storage 105) by the capture service 100 through various communication channels, for example via phone (e.g., telephony or voice over Internet protocol (VoIP)), messaging services (e.g., simple messaging service (SMS) or multimedia messaging service (MMS)), or email. For example, a voice/text server 110 may be provided to receive voice, text, or multimedia messages; perform initial processing (including parsing and analysis of the message); and transfer the processed message to the capture service 100. The voice/text server 100 may include a phone receiver with a transcriber.

An email server 115 may be provided to receive email messages; perform initial processing (including parsing and analysis of the message); and transfer the processed message to the capture service.

The capture service 100, voice/text server 110, and email application server 115 may be implemented using one or more physical and/or virtual servers communicating over a network. The network can include, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

A phone 120 (such as a land-line, cell phone, or smart phone) may be used to call or text a number (depending on the capabilities of the phone 120) to provide a message that may be routed to the voice/text server 110. A cell tower 125 or traditional telephony infrastructure may be used. In some cases, the voice and/or text may be transmitted over Wi-Fi_{—}33 to a network such as the Internet (for example via VoIP).

An email application 130 running on a client computing device 135 may be used to send an email message over a network to an email address of an email service handled by the email server 115. The client computing device 135 may be, but is not limited to, a personal computer, a tablet, a reader, a mobile device, a personal digital assistant (PDA), a smartphone, a laptop (or notebook or netbook) computer, a gaming device or console, a desktop computer, or a smart television.

A notebook application 140 running on a client computing device 145 can be used to view and modify a note having content inserted via one of the communication channels (e.g., voice/text, email) to the capture service 100. The client computing device 145 may be, but is not limited to, a personal computer, a tablet, a reader, a mobile device, a personal digital assistant (PDA), a smartphone, a laptop (or notebook or netbook) computer, a gaming device or console, a desktop computer, or a smart television. The notebook application 140 may be a notebook client in the form of a web-based application, a native notebook application, or even a clipping tool. In addition to viewing and modifying the note, the notebook application 140 can also be used provide content to a note using the capture service 100.

The client computing device 145 may be a same or different device than that used to generate and transmit the content to the note. For example, in addition to a notebook application 140, the client computing device 145 can include a text messaging application 150 and/or an email application 155. A user of client computing device 145 may send content to a note via the text messaging application 150 or the email application 155 and then view the content in the note via the notebook application 140.

One example scenario involves the communication channels of short message service (SMS) and multimedia messaging service (MMS) messaging. A user may send a message to an email or number contact for the notebook service, which determines to which user's account the message is provided. In one implementation a user can send a message to a generic number (or email) contact through SMS or MMS. Having the notebook service as a contact (for example as “MyNotebook”) can further facilitate the transfer of information to a capture service and the user's notebook.

Even an instant message style communication channel (such as a mobile instant messaging or embedded web browser service) may be used where the “person” being chatted with is the capture service that receives the message. In addition, some scenarios may involve a telephone (telephony system) or Voice Over Internet Protocol (VoIP) communication channel where a message center may receive audio information, (optionally) convert to text, parse (before or after conversion), and potentially augment the message before inserting into a note.

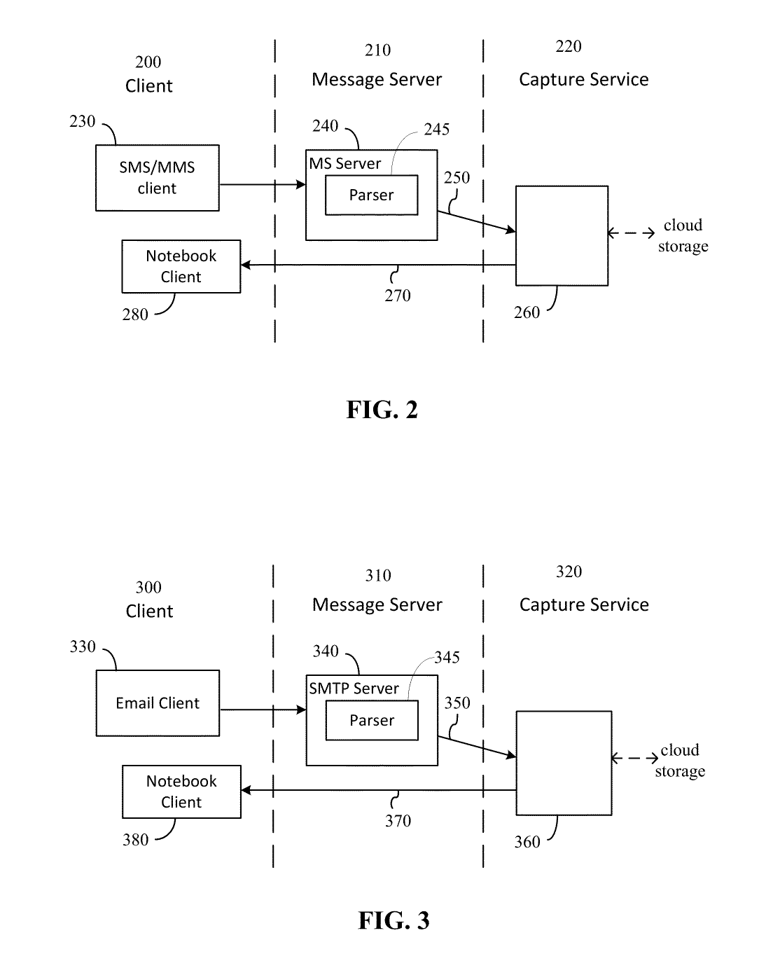

FIG. 2 illustrates a system architecture diagram and process flow for an example implementation of a messaging communication channel. Referring to FIG. 2, an operating environment in which certain implementations may be carried out can include a client 200, which may include one or more computing devices such as a mobile phone, laptop, tablet, desktop, game console, or smart television; a message server 210 such as a SMS or MMS server; and a capture service 220. A user can send a message via a SMS/MMS application 230 at a client 200 to a message server 210 such as provided by a host messaging server 240 (or servers). The message received by the host messaging server 240 can be parsed in a parser 245, and the parsed message 250 provided to a capture service 220 for additional processing. The capture service 220 can be associated with or include a notebook service 260.

Once the message is received and acted upon, the information sent in the message can be stored in a storage associated with the user's account (e.g., cloud storage) and then made available in a determined presentation form to a user through the user's notebook application 280 at the client 200.

Another example scenario involves the communication channel of email. Capturing information by email allows a user to enter data into a notebook service through an activity that a user is familiar with. In addition, the interface with a notebook service facilitates the application of the features available from a notebook service, which tend to be more robust than an email or other message service. For example, certain viewing, formatting, organizing, and enhancing are available from a notebook service and these features may not be available from within an email or other message application.

A user may send a message to a uniform contact address. The contact address can be considered uniform because a same contact address may be used by multiple users and the service determines to which user's account the message is provided. In one implementation, a user can send an email to a generic email address such as me@notebookservice.com. In this manner it can appear that the user is sending an email to themselves; however, since the message is being sent through to a capture service after being received by an email server, the content of the email can be inserted into a note and the features of a notebook application applied to the content. In other scenarios, different email addresses may be used for multiple users. For example, a personalized email (e.g., my*name1 @notebookservice.com) can be used for inserting content into a note associated with one user's account through an email communication channel.

FIG. 3 illustrates a system architecture diagram and process flow for an example implementation of an email communication channel. Similar to that described with respect to FIG. 2, the operating environment in which certain implementations may be carried out can include a client 300, which may include one or more computing devices such as a mobile phone, laptop, tablet, desktop, game console, or smart television; a message server 310; and a capture service 320. The message server shown in FIG. 3 may be a simple mail transfer protocol (SMTP) server. A user can send a message via an email application at a client 300 to a message server 310 such as provided by a host server 340 (or servers). For an email communication channel, the host server 340 can be an SMTP server or service.

Filtering can be performed on the incoming message to handle spam and denial of service attacks. At the host SMTP server 340, the message sent to the notebook service email can be parsed in a parser 345. The parser 345 can include a multipurpose internet mail extension (MIME) parser and can perform advanced semantic parsing.

The parsed message can be provided to a capture service 320 for additional processing. The capture service 320 can be a cloud service providing or run on a designated server. The capture service 320 can be associated with or include a notebook service 360. Once the email or other message is received and acted upon, the information sent in the message can be stored in a storage associated with the user's account (e.g., cloud storage) and then made available in a determined presentation form (e.g., note 370) to a user through the user's notebook application 380 at the client 300.

A parser (such as parser 245 or 345) may be embodied as a computing system including a processor and memory. In some cases, the parser may be implemented in software stored on one or more computer-readable storage media. In some cases, the parser may be implanted in hardware, for example through programmable logic or gate arrays. Certain aspects may be embodied as part of a system on a chip (SoC). In some cases, the parser may be distributed over a number of servers and computing systems. In some cases, the parser may be embodied in a combination of hardware and software modules.

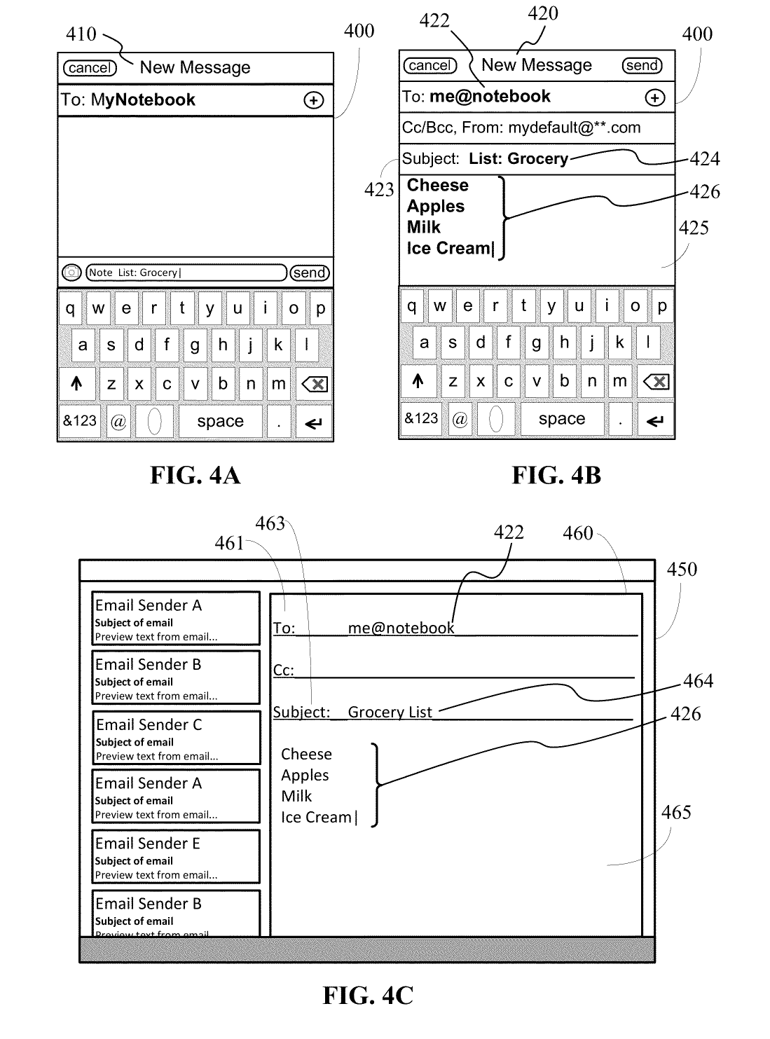

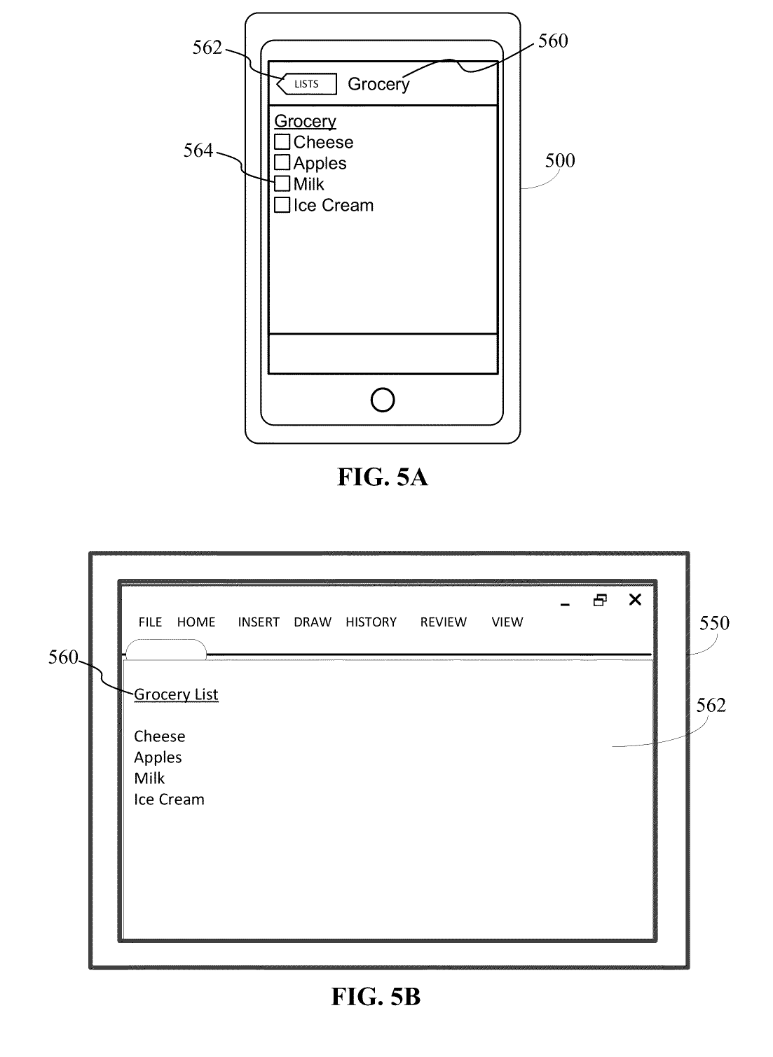

An example use case is illustrated in FIGS. 4A-4C and 5A-5B for capturing a quick to-do of a grocery list. A user may be messaging friends on his mobile device 400 and realize that he should pick up certain items from the grocery store later that week. In one implementation, such as illustrated by FIG. 4A, the user can tap a compose button from within the messaging application interface to start a new message 410. The notebook service can have a number or other contact with SMS or MMS capabilities. The user can enter text (or even add a photograph or other multi-media input) to send as a message to the notebook service for insertion into their note.

If the user was in an email application on a mobile device 400, such as illustrated by FIG. 4B, the user can tap a compose button from within the email application interface to start a new message 420. The notebook service can have an email address 422 to which a user can send the message to capture that information for later consumption in a note. As further illustrated in FIG. 4B, the user may add a subject 423 called “List: Grocery” 424 and then in the body 425 type out the items 426 of the list. Punctuation and formatting is not a requirement for the list to be understood by the service. For example, in FIGS. 2B and 2C, a number of items 426 can be typed, each separated by hitting “return”.

Similarly, if the user was in an email application on a tablet or laptop device 450 such as illustrated by FIG. 4C, the user can click or tap on a compose button from within the email application interface to start a new message 460. The user can select or enter, in the “To Field” 461, the uniform email address 422, enter a subject 463 called “Grocery List” 464 (or List:Grocery 424 such as shown in FIG. 4B or another arrangement/syntax), and type a number of items 426 into the body 465 of the email.

Each item of the list of items 426 may be a recognized entity (or a term associated with a recognized entity). Once the email is sent from the user's account, the email server can parse the message and determine where the content belongs (and to which user(s) and, in some cases, specific note). In addition to entering new content in a new email, emails (from another user or another account of the same user) may be forwarded to the notebook service through the email address (e.g., me@notebook), simplifying content capture by the user doing the forwarding.

When a message is received through a communication channel, the elements of the message (as well as information associated with the communication channel) are analyzed to recognize semantic structure, which enables further analysis as well as facilitating format and arrangement when the content is inserted in the note, and to determine presentation form, which facilitates selection of augmentations and enhancements to the content when inserted into a note.

The determining of presentation form can be considered to be a result of discerning the intent of the message. For example, the intent of a message containing multiple entities (that may be ontologically related) separated by a semantic marker (such as a comma or end of line/end of paragraph marker) may be discerned to be forming a list. A determination that “todo” or “do” is in the message may indicate intent to provide a task list. When the system discerns such intent, it can be determined that the presentation form is a task list. The entities (discerned from the items included in the message content) may be presented in a list. In some cases, the presentation of a task list can include an augmentation such as a check box by each item.

In addition to presentation form, the message itself (through syntax and semantics) can provide an indicator of relevant external information and useful actions such as tagging and interacting with other services.

Referring to FIGS. 5A and 5B, when the user opens their notebook application on a mobile device 500 (such as a cell phone or smartphone) or tablet or personal computer 550, the content provided through the communication channel of text or email appears in a note. The content can be augmented by the service receiving the content to provide a more robust user experience. For example, the “List: Grocery” 424 from the subject 423 of an email (or even the body of the text or email) may be entered into a page 560 called “Grocery” in a section called “Lists” where each item is automatically added with a checkmark box 564 that can be checked off as the item is obtained. Similarly, the “Grocery List” 464 provided in the subject 461 of an email (as shown in FIG. 4C) can be used as a heading 560 on a new page 562 of a note.

According to certain implementations, method of capturing content through a communication channel includes receiving a message from a user over a communication channel and parsing the message content for syntax, semantics, and pragmatics. The parsed message can then be used to present the message in a format suitable for a notebook application or other application to utilize and even enhance or augment. The syntax parsing can be performed to determine one or more entities and groupings of entities in a message. The syntax parsing can include recognizing delimiters and semantic markers, which are then used to determine the semantics of the message. The semantics parsing can be performed to determining meaning of the message such its context and content. In many cases, messages having different syntax may have the same meaning. The pragmatics parsing can be performed to determine the application and purpose (or intent) of the message.

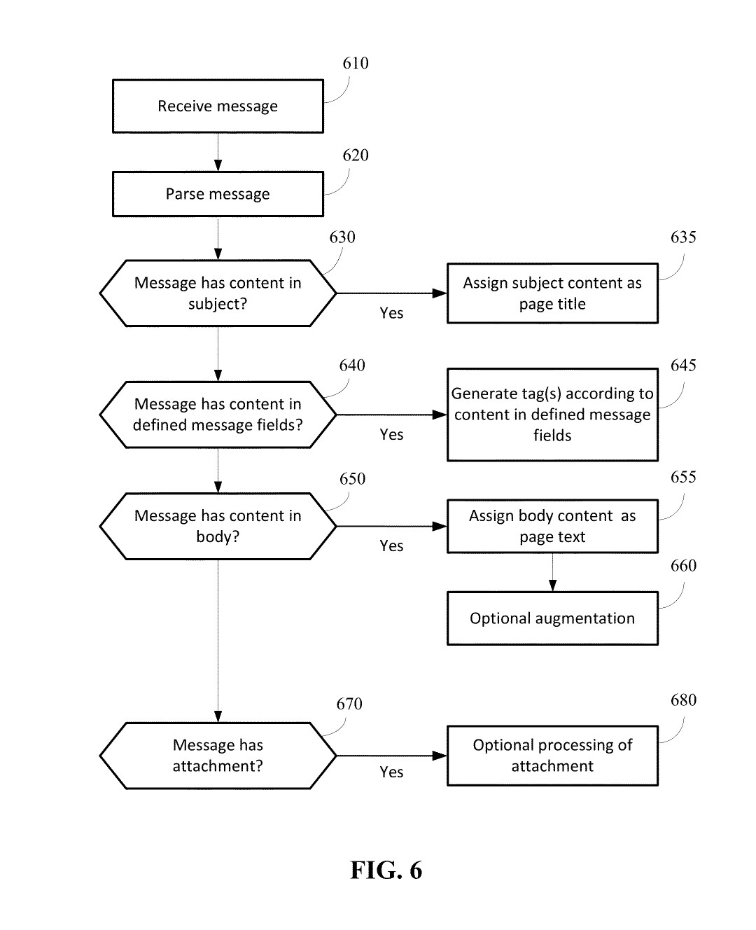

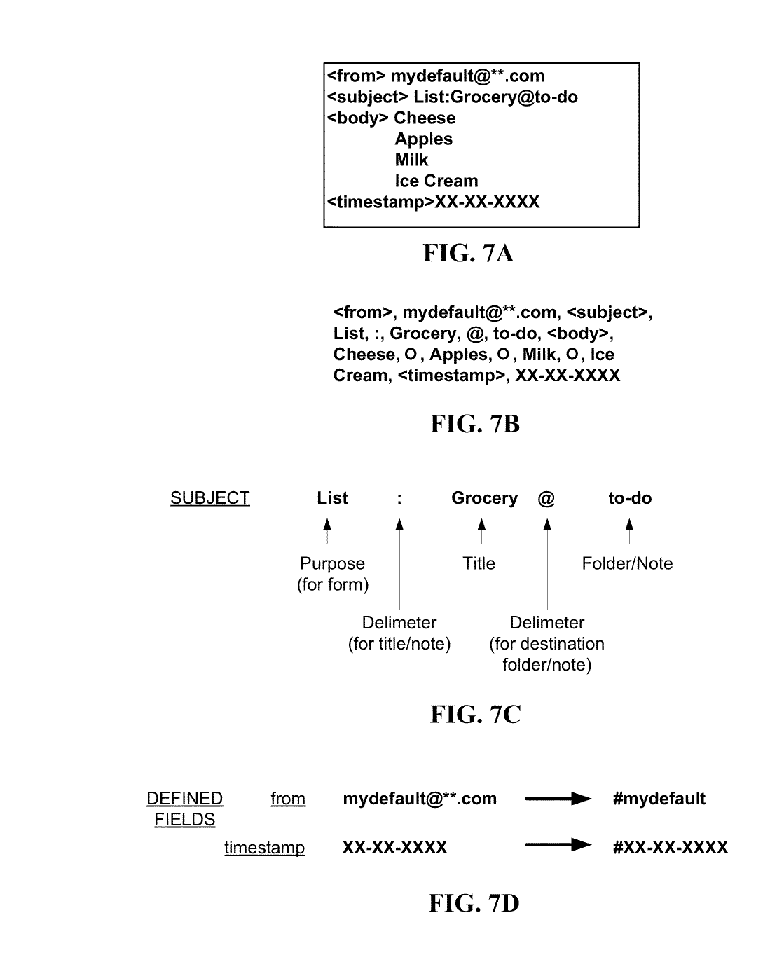

FIG. 6 illustrates an example method of capturing content through a communication channel; and FIGS. 7A-7D illustrate representative steps that may be carried out when performing an example method of capturing content through a communication channel.

In some cases the method steps may be carried out in a message server (or as part of a message service) that receives the message. For example, a message can be received by the message service (610). The message may be sent via a communication channel such as email, SMS, MMS, or text. Once the message is received (610), the message can be sent to a parser to parse the message (620).

For example, as shown in FIG. 7A, a message 700 can include, but is not limited to, a “from” field 702, “subject” field 704, “body” field 706, and “timestamp” field 708. Certain implementations of the parser are configured to recognize elements of a message in order to facilitate the organization and augmentation of message content. Words, themes, and relationships can be detected at the parser once the parser recognizes tokens (such as shown separated by commas in FIG. 7B). Although not described in detail herein, in some cases, the parser can include natural language parsing as well as other advance parsing techniques.

Returning to FIG. 6, if the message has content in the subject field (630), the content parsed from the subject field can be assigned as a page title for a note (635). Additional features, tags, or assignments can be provided based on syntax, semantic and/or pragmatic determinations with respect to the tokens in the subject field. For example, the subject field example shown in FIG. 7C includes the tokens “List”, “:”, “Grocery”, “@”, and “to-do”.

The system (through a processor of a server hosting the messaging service or parser) can assign or tag the “List” as the purpose/intent for how the content is to be presented (e.g., presentation form) or as a note section. The detection of a delimiter (shown as “:” in the example, but it should be understood that embodiments are not limited to the specific meanings or selections for the delimiters—only that the system can recognize that a delimiter is being used) can indicate that the word or words following the delimiter indicate a title or heading for the note. The system can then assign or tag the message with “Grocery” as the title.

The detection of the delimiter “@” may be used to indicate that the following token(s) relate to the name of the destination folder or note. In this example, “to-do” is provided as the name of the folder or note. Thus, when the messaging service provides the parsed message to a capture service (for example, for insertion into a note), the capture service can perform further actions based on the parsed message and even facilitate the presentation form and enhancement or tagging of the content.

If the message has content in defined message fields (640), for example, the message fields of “from” and “timestamp” such as shown in FIG. 7D, tags may be generated according to the content in the defined message fields (645). These tags may be later used within the notebook application to sort or perform other actions. The tags may be invisible to a user.

Content in the body of the message (650) can be assigned as page text (655). Additional actions, enhancements and/or augmentation (660) may be carried out so that the page text automatically includes features and formatting beyond that provided in the message.

In some cases, an email or message may have an attachment. The attachment may be a text file (e.g., Hypertext Markup Language (HTML), text), image file (TIFF, GIF), application file (ZIP, ADOBE ACROBAT), audio file (AUDIO, WINSOUND), video file (APPLE QUICKTIME), or some type of unmapped file (postscript, bitmap, MICROSOFT EXCEL). If an attachment is provided with the message (670), then the attachment may be inserted into a note as-is or with optional processing (680). The processing (680) may include parsing, modifying for format, or other action including tagging or associating with related metadata.

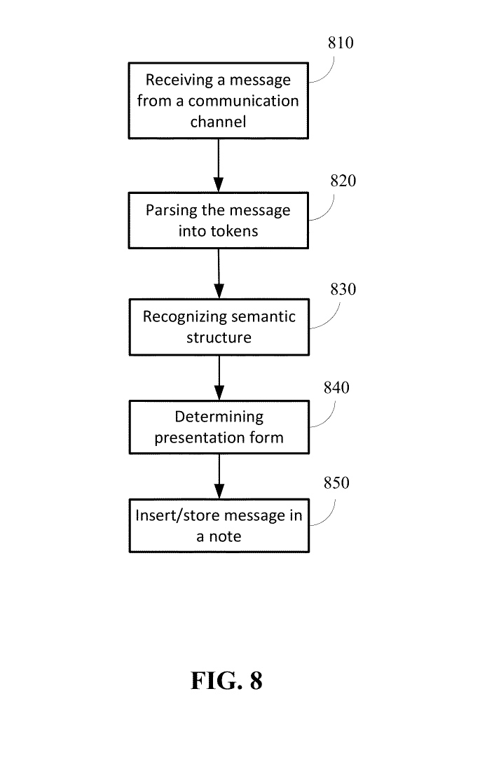

FIG. 8 illustrates a method of capturing content through a communication channel. Referring to FIG. 8, a message may be received from a communication channel (810). The received message can be parsed into tokens including elements and semantic markers in the message (820). Semantic structure can be recognized from the tokens (830). Then, the presentation form can be determined (840) and the message can be inserted (and stored) in a note according to the determined presentation form (850). Metadata can be included based on the recognized semantic structure(s). In some cases additional information or content can be included based on the recognized semantic structure(s). For example, a search engine or web page may be accessed to return additional information related to the recognized semantic structure(s).

In some implementations, an ontology database may be used to facilitate recognizing semantic structure. “Ontology” refers to the hierarchy of concepts incorporated under a classification and supplemented with semantic relations that further define how the concepts are interrelated. Each concept may be an entity and the ontology provides the framework of entities within a domain.

As an example, the ontology database can be used to recognize an entity of “broccoli” in a list arrangement in a message. The “broccoli” entity can be marked (or tagged) as a vegetable and even as a sub-class of commodity. A movie title or game ticket information may be marked or tagged as related to entertainment. The capture service can then use the marked/tagged content to perform further processing, make predictions, or include augmentations.

For example, one process includes receiving an email; parsing the email and determining content of the email; recognizing an entity from the content; determining metadata associated with the entity; and inserting the metadata into a note. Parsing the message can include recognizing the entity (or entities), recognizing semantic meaning of tokens of the message, creating a relation between two or more recognized entities, or recognizing a relationship between the entities.

In one case, the semantic entity may be grocery list. In another case, the semantic entity may be that the message comes from an email (and will include certain entities that exist because the message is an email). In yet another case, the semantic entity may be a naturally worded request for the user to be reminded about something at a specific time. One presentation (or intent) that can be determined from such a semantic entity can be a calendar event, for example created as a reminder in a calendar client.

The method shown in FIG. 8 may be carried out in whole or in part by a capture service. In some cases, the method can be carried out by a parser or parsing service. In one implementation, a message capture portion of the capture service and/or a parsing service can provide a single point across multiple communication methods to which content can be sent in order to insert content into a note or store in some other manner.

An example implementation can begin with an email client, for example through MICROSOFT OUTLOOK available from Microsoft Corp. or GMAIL available from Google Inc. A user may prepare an email to a designated email address associated with a capture email service. The capture email service can be associated with a notebook application such as ONENOTE available from Microsoft Corp. A message sent from an email client may be received by a capture email service and filtered. The filtering can include whitelists, blacklists, URL screeners, malware/virus scans and other mechanisms for minimizing denial of service attacks and spam. Once the mail is deemed to be clean, the mail can be passed to a SMTP receiver, which includes a MIME parser. The MIME parser can parse the message into tokens. The MIME parser can begin analyzing, parsing and streaming the parts of the mail such as “from,” “subject,” “body,” “metadata,” and “attachments.”

Using the sender's email address, a call can be made to a service that can authenticate a user of the notebook application to obtain a user's account information (to which the email contents will be inserted or saved in associated with).

When the server is not able to identify the note to which the message is to be included, the service may send a communication to the user through the same or a different communication channel requesting a reply with additional information or informing the user on how to retrieve the content (where it is stored). For instance, if the user sends a message to the service and the service does not recognize the email address or phone number or is unable to authenticate the user, the service can respond with a mail that can either guide the user through setting up an account or, in some cases, enable a user to set up an account through via email (or SMS, MMS or voice message) by responding with the requisite information.

The method can include analyzing the message for a probable use or purpose of the content. This may be thought of as determining the intent of the message. Embodiments may therefore determine the presentation form of content that is received through a communication channel through the analysis of the message. The presentation form involves how the content from the message is arranged and located in a note. In further implementations, the presentation form includes augmentations to the content such as the addition of functionality, tags, and related content.

In some cases, analyzing the message for a probable use or purpose may include using content found in a certain field or fields of the message. For example, a word or words found in the subject of an email message can be used as a title for a new note or an indication of an existing note of a user's account to which the message content is to be inserted. Certain semantic markers may indicate a particular purpose for the content. For example, the semantic marker “@” or “:” may indicate a relationship between a word before the semantic marker and the word after the semantic marker.

One example of how this can function can be “list@todo” found in a subject of an email. The tokens “list,” “@,” and “todo” may be parsed with the semantic marker “@” recognized between two entities “list” and “todo”.

The recognized entity “list” may indicate that the intent/purpose of at least some of the content in the message is to be a list and the existence of this recognized entity may result in a determination that the presentation form for the content includes a list. The semantic marker “@” found in a subject may indicate that the word(s) following the marker provide a name of the note to which the content is to be inserted. Thus, the entity “todo” following the semantic marker “@” may indicate that the name of the note to contain the list is “todo”. This may be an existing note or a new note.

In some implementations, the recognized entity “todo” may further indicate that the intent/purpose of the content relates to tasks and, in some cases, the existence of this recognized entity may result in a determination that the presentation form for the content includes a presentation suitable for tasks. For example, a calendar or timing related arrangement may be presented and/or augmentations relating to scheduling may be included with the tasks. Having one or both of “list” and “todo” may include a presentation form that shows identified entities in a tabular manner with one entity (or string) for each line/row along with a checkbox or other enhanced functionality.

It should be understood that enhancements are not necessarily included and, in some cases, beyond inserting content from a message into a note (perhaps along with metadata indicating the communication channel from which the message was received), no other actions or augmentations may be performed with respect to the message. In such a case, the “intent” may be determined as “to insert message into a note” and the presentation form can be a default form that may involve an image representation, a simple text, or other formatting and font as used by the notebook application.

The presentation form (and optional augmentation and/or tagging) may be determined through an analysis of syntax, semantics and/or pragmatics. In some cases, when a certain word is recognized from the content of a message (or a particular field of a message), then a particular presentation form may be selected and used. In some cases, the presentation form can be determined and certain options for the presentation form (and optional augmentation and/or tagging) selected in response to recognizing certain patterns and/or ontological relationships between entities recognized in the message.

In some cases, the presentation form can be determined and certain options for the presentation form (and optional augmentation and/or tagging) selected in response to recognizing certain semantic arrangements or a combination of certain recognized entities in a particular semantic arrangement. In some cases one or all of these cases may apply.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Computer-readable media can be any available computer-readable storage media or communication media that can be accessed by the computer system.

Communication media include the media by which a communication signal containing, for example, computer-readable instructions, data structures, program modules, or other data, is transmitted from one system to another system. The communication media can include guided transmission media, such as cables and wires (e.g., fiber optic, coaxial, and the like), and wireless (unguided transmission) media, such as acoustic, electromagnetic, RF, microwave and infrared, that can propagate energy waves. Carrier waves and other propagating signals that may contain data usable by a computer system are not themselves “computer-readable storage media.”

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” do not consist of carrier waves or propagating signals.

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Example scenarios have been presented to provide a greater understanding of certain embodiments of the present invention and of its many advantages. The example scenarios described herein are simply meant to be illustrative of some of the applications and variants for embodiments of the invention. They are, of course, not to be considered in any way limitative of the invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A method of capturing content through a communication channel, comprising:
receiving a message from a communication channel;
parsing the message and determining semantic structure of the message;
determining a presentation form from elements in the message; and
inserting the message into a note according to the presentation form.

2. The method of claim 1, wherein the communication channel comprises an email service.

3. The method of claim 1, wherein the communication channel comprises a short messaging service or multi-media messaging service.

4. The method of claim 1, wherein the communication channel comprises a telephony system or Voice Over Internet Protocol.

5. The method of claim 1, wherein determining the presentation form from the elements in the message comprises:
analyzing the semantic structure and the elements of the message to select the presentation form.

6. The method of claim 5, wherein analyzing the semantic structure and the elements of the message to select the presentation form comprises:
analyzing content in a subject field of the message.

7. The method of claim 5, wherein analyzing the semantic structure and the elements of the message to select the presentation form comprises:
analyzing content in a body of the message including identifying entities and ontological relationships between identified entities.

8. The method of claim 1, further comprising:
recognizing one or more entities from the elements of the message;
determining metadata associated with each recognized one or more entities; and
inserting the metadata with the message into the note.

9. The method of claim 1, further comprising inserting the message into the note with metadata based on the semantic structure.

10. A message service for a capture service comprising:
a message receiver configured to receive a message from a communication channel; and
a parser configured to parse the message into tokens including elements and semantic markers in the message; recognize semantic structure of the elements in the message; and determine a presentation form from the elements in the message.

11. The message service of claim 10, wherein the parser is further configured to output a parsed message for inserting into a note according to the presentation form in response to receiving the message with an address associated with a notebook service.

12. The message service of claim 10, wherein the message receiver comprises an email service receiver.

13. The message service of claim 10, wherein the message receiver comprises a short messaging service receiver or a multi-media messaging service receiver.

14. The message service of claim 10, wherein the message receiver comprises a telephony system receiver or a Voice Over Internet Protocol receiver.

15. A method comprising:
receiving a message at a message service, the message having a source semantic structure based on a source of the message;
parsing the message;
determining content of the message and recognizing one or more entities using the source semantic structure;
determining metadata associated with the one or more entities; and
storing the metadata associated with the message for inserting into a note.

16. The method of claim 15, wherein the source of the message is email.

17. The method of claim 16, further comprising:
in response to recognizing a first entity in a subject field of the message, assigning the first entity as a page title of the note;
in response to recognizing a second entity in a defined message field of the message, storing the second entity as a second metadata associated with the message; and
determining presentation form from at least the content and one or more entities.

18. The method of claim 15, wherein the source of the message is SMS or MMS.

19. The method of claim 15, wherein the message comprises the content and an attachment.

20. The method of claim 18, further comprising:
recognizing one or more attachment entities by parsing the attachment;
determining attachment metadata associated with the one or more attachment entities; and
storing the attachment metadata associated with the attachment for inserting into the note.
